(19) United States
(12) Patent Application Publication
(10) Pub. No.: US 2016/0076683 A1
(43) Pub. Date: Mar. 17, 2016

(54) Coupling Assembly for a Pipe and Valve Assembly Comprising the Same

(71) Applicant: Lorax Systems, Inc., Halifax (CA)

(72) Inventors: Mark Bishoff, Halifax (CA); Guy Bishoff, Lethbridge (CA)

(73) Assignee: Lorax Systems, Inc., Halifax (CA)

(21) Appl. No.: 14/949,487

(22) Filed: Nov. 23, 2015

Related U.S. Application Data
(63) Continuation-in-part of application No. 14/371,781, filed on Jul. 11, 2014, now Pat. No. 9,195,240.

(51) Int. Cl. F16L 29/00; F16K 15/18; F16L 15/08; F16K 17/04

(52) U.S. Cl. CPC F16L 29/007; F16K 17/04; F16K 15/18; F16L 15/08

(57) ABSTRACT

A valve assembly comprising: a body having a threaded tubular connector sized and shaped to receive a pipe having a first fluid line; a primary passageway defined through the body and the tubular connector for connection to the first fluid line; a valve disposed in the primary passageway; and a coupling assembly for sealingly connecting the pipe to the body, the coupling assembly including: an annular compression member adapted to be disposed around the pipe, the annular compression member threadingly engaging the tubular connector such that rotation of the compression member selectively moves the annular compression member axially towards and away from the body; and an O-ring seal adapted to be disposed concentrically around the pipe between the annular compression member and the body, the O-ring being compressed when the annular compression member is moved towards the body to create a seal between the pipe and the body.

### CROSS-REFERENCE TO RELATED APPLICATIONS

This application is a continuation-in-part of U.S. patent application Ser. No. 14/371,781, filed on Jul. 11, 2014, which is a §371 National Phase of PCT/CA2013/000810, filed on Sep. 24, 2013, which claims priority on U.S. Provisional Patent Application No. 61/713,286, filed on Oct. 12, 2012, the entireties of which are incorporated herein by reference.

### TECHNICAL FIELD

The present relates to valves and more specifically to valves assemblies having at least one safety mode. The present further relates to coupling assemblies for sealingly connecting a pipe to a body and to valve assemblies and systems comprising the same.

### BACKGROUND

Pipes, hoses and other flow lines can be used to connect a source of fluid, for example an oil tank, to a recipient, for example a furnace. The connection generally includes one or more adapter(s) that connect fittings on a flow line to those on the oil tank and the furnace. When the connection is made between the oil tank and the furnace, the fluid, oil in this example, flows freely through the flow line from the oil tank to the furnace. There are circumstances in which the flow of fluid may need to be interrupted. For example, the adapters may be sheared apart if hit, thereby causing a leak. In other examples, the flow line may rupture from the corrosive effect of the oil. The flow may also be interrupted for maintenance reasons in the absence of any failure of the connection.

Shut-off valves for closing a flow path include breakaway safety valves adapted to break when the valve is subjected to a shearing force of predetermined magnitude. Other valves include safety shut off valves which have a circumferential area of weakness therearound so that if the body is severed along the area of weakness, a stop member is removed and a poppet is allowed to close to prevent fluid flow through the body. Other devices may include a valve comprising a piston controlled shut-off valve, where the piston is spring biased to a valve-closed position and is moved against the spring bias to a valve-open position by normal operating pressure. A drop from normal operating pressure causes the piston to close the valve thereby isolating the faulty circuit. Yet other valves assembly include automatic safety valve closure systems which include a delivery pipe surrounded by a second pipe. The volume between the pipes is filled with an inert fluid, for example water. If the delivery pipe is broken or springs a leak, the change in water pressure will cause the valve to close. These and other known valves are configured to close in response to only one mode of failure of the system they occupy, although other modes of failures may be present, and are also not adapted to deliver high pressure gas.

### BRIEF SUMMARY

According to one aspect, there is provided a valve assembly comprising: a body having a first end, a second end and a tubular connector extending away from the second end, the tubular connector being sized and shaped to receive a pipe having an outer sidewall and a first fluid line, the tubular connector having a first connector end located towards the second end of the body and a second connector end located away from the second end of the body, the tubular connector further having a threaded outer surface; a primary passageway defined through the body and the tubular connector, the passageway having a first end coinciding with the first end of the body and a second end coinciding with the second connector end, the second end of the primary passageway being adapted to be connected to the first fluid line; a valve disposed in the primary passageway between the first end and the second end thereof, the valve being movable between a first position in which the primary passageway is open and fluid communicates between the first end and the second end of the primary passageway, and a second position in which the primary passageway is closed and fluid is prevented from communicating between the first end and the second end of the primary passageway; and a coupling assembly for sealingly connecting the pipe to the body, the coupling assembly including: an annular compression member disposed concentrically around the tubular connector, the annular compression member being further adapted to be disposed around the outer sidewall of the pipe, the annular compression member threadingly engaging the threaded outer surface of the tubular connector such that rotation of the compression member selectively moves the annular compression member axially towards and away from the body; and an O-ring seal adapted to be disposed concentrically around the outer sidewall of the pipe between the annular compression member and the first end of the body, the O-ring being compressed when the annular compression member is moved towards the body to create a seal between the pipe and the body.

In one embodiment, the coupling assembly further comprises a bushing adapted to be disposed concentrically around the pipe, between the annular compression member and the O-ring seal.

In one embodiment, the bushing comprises a corrugated internal surface adapted to engage a corresponding corrugated external surface of the pipe.

In one embodiment, the valve assembly further comprises a fitting assembly mounted to the outer sidewall of the pipe, the fitting assembly being adapted to be received within a bore of the body, the bore being located at the second end of the primary passageway.

In one embodiment, the fitting assembly comprises an outer ring adapted to engage a first end of the outer sidewall of the pipe and an inner ring adapted to engage the outer ring for locking the outer ring on the outer sidewall of the pipe.

In one embodiment, the outer ring comprises a base ring and a plurality of resilient fingers extending from the base ring.

In one embodiment, the base ring is adapted to receive an inner sidewall of the pipe, the inner sidewall being spaced radially inwardly from the outer sidewall.

In one embodiment, the fitting assembly comprises a collar adapted to be disposed around the inner sidewall of the pipe, the collar being located within the bore of the body, the inner ring member of the fitting assembly having an inner diameter and the clamp member having an outer diameter greater than the inner diameter of the inner ring.

In one embodiment, the valve assembly further comprises a secondary passageway defined in the body, the secondary passageway having a first end and a second end, the secondary passageway being fluidly isolated from the primary passageway, the second end of the secondary passageway being adapted to be connected to a second fluid line of the pipe, the first fluid line being disposed coaxially within the second fluid line.

In one embodiment, the first pressure in the primary passageway is greater than the second pressure in the secondary passageway, and an environment pressure is greater than the second pressure in the secondary passageway.

In one embodiment, the valve assembly has at least one safety mode whereby the valve closes the primary passageway in response to an increase of the second pressure in the secondary passageway.

In one embodiment, an increase of the second pressure in the secondary passageway is a consequence of at least one of a leak between the first fluid line and the second fluid line and a leak between the second fluid line and the environment.

In one embodiment, the valve includes a spring loaded ball selectively abutting a seat of the primary passageway; in the open position, the ball is spaced away from the seat; in the closed position, the ball abuts the seat; and the spring biases the ball toward the closed position.

In one embodiment, the valve assembly further comprises a piston selectively abutting the ball; the piston is disposed vertically below the ball opposite from the spring; the piston is movable between an upper position and a lower position, wherein in the upper position, the piston abutting the ball and displacing the ball upward away from the seat thereby moving the valve in the open position; in the lower position, the piston induces the ball to move downward toward the seat thereby moving the valve in the closed position.

In one embodiment, in the upper position, the piston abuts the ball; in the lower position, the piston is spaced away from the ball and lets the ball move downward toward the seat under the influence of the spring.

According to another aspect, there is also provided a coupling assembly for sealingly connecting a pipe to a body, the body having a first end, a second end and a tubular connector having a first connector end connected to the second end of the body and a second connector end located away from the second end of the body, the body further having a primary passageway defined through the body and the tubular connector, the tubular connector further having a threaded outer surface, the coupling assembly comprising: an annular compression member adapted to be disposed concentrically around the tubular connector, the annular compression member being further adapted to be disposed around the pipe, the annular compression member threadingly engaging the threaded outer surface of the tubular connector such that rotation of the compression member selectively moves the annular compression member axially towards and away from the body; and an O-ring seal adapted to be disposed concentrically around the pipe between the annular compression member and the first end of the body, the O-ring being compressed when the annular compression member is moved towards the body to create a seal between the pipe and the body.

According to yet another aspect, there is also provided a valve system comprising: a pipe having an outer sidewall and an inner sidewall spaced radially inwardly from the outer sidewall to define an interstitial space therebetween, the inner sidewall defining a first fluid line and the interstitial space defining a second fluid line; a valve assembly including: a body having a first end, a second end and a tubular connector extending away from the second end, the tubular connector being sized and shaped to receive the pipe, the tubular connector having a first connector end located towards the second end of the body and a second connector end located away from the second end of the body, the tubular connector further having a threaded outer surface; a primary passageway defined through the body and the tubular connector, the passageway having a first end coinciding with the first end of the body and a second end coinciding with the second connector end, the second end of the primary passageway being adapted to be connected to the first fluid line; a valve disposed in the primary passageway between the first end and the second end thereof, the valve being movable between a first position in which the primary passageway is open and fluid communicates between the first end and the second end of the primary passageway, and a second position in which the primary passageway is closed and fluid is prevented from communicating between the first end and the second end of the primary passageway; and a coupling assembly for sealingly connecting the pipe to the body, the coupling assembly including: an annular compression member disposed concentrically around the tubular connector, the annular compression member being further adapted to be disposed around the outer sidewall of the pipe, the annular compression member threadingly engaging the threaded outer surface of the tubular connector such that rotation of the compression member selectively moves the annular compression member axially towards and away from the body; and an O-ring seal adapted to be disposed concentrically around the outer sidewall of the pipe between the annular compression member and the first end of the body, the O-ring being compressed when the annular compression member is moved towards the body to create a seal between the pipe and the body.

Embodiments of the present can have at least one of the above-mentioned aspects, but do not necessarily have all of them.

Additional and/or alternative features, aspects, and advantages of embodiments of the present will become apparent from the following description, the accompanying drawings, and the appended claims.

### BRIEF DESCRIPTION OF THE DRAWINGS

For a better understanding of the present, as well as other aspects, and further features thereof, reference is made to the following description which is to be used in conjunction with the accompanying drawings, where:

FIG. 1 is a longitudinal cross-sectional view of a valve assembly in accordance with one embodiment, with a valve in an open position;

FIG. 2 is a longitudinal cross-sectional view of the valve assembly shown FIG. 1, with the valve in a closed position;

FIG. 3 is a longitudinal cross-sectional view of a valve assembly in accordance with a another embodiment, with a valve in an open position;

FIG. 4 is a longitudinal cross-sectional view of FIG. 3 shown with the valve in a closed position;

FIG. 5 is a longitudinal cross-sectional view of a valve assembly in accordance with yet another embodiment, with a valve in an open position;

FIG. 6 is an enlarged cross-sectional view of the valve assembly of FIG. 5, taken from area VI;

FIG. 7 is another enlarged cross-sectional view of the valve assembly of FIG. 6, also taken from area VI and with the coupling assembly and the fitting assembly partially exploded; and

FIG. 8 is a perspective view of the valve assembly of FIG. 5, with the coupling assembly and the fitting assembly partially exploded.

### DETAILED DESCRIPTION

The description which follows, and the embodiments described therein are provided by way of illustration of an example, or examples of particular embodiments of principles and aspects of the present discovery. These examples are provided for the purpose of explanation and not of limitation, of those principles of the discovery. In the description that follows, like parts are marked throughout the specification and the drawings with the same respective reference numerals.

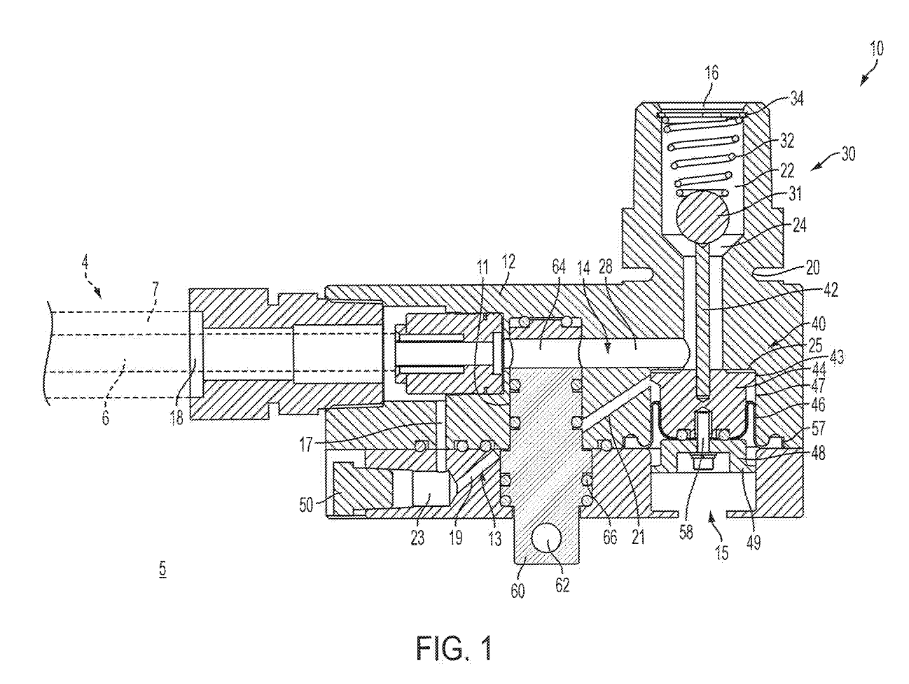

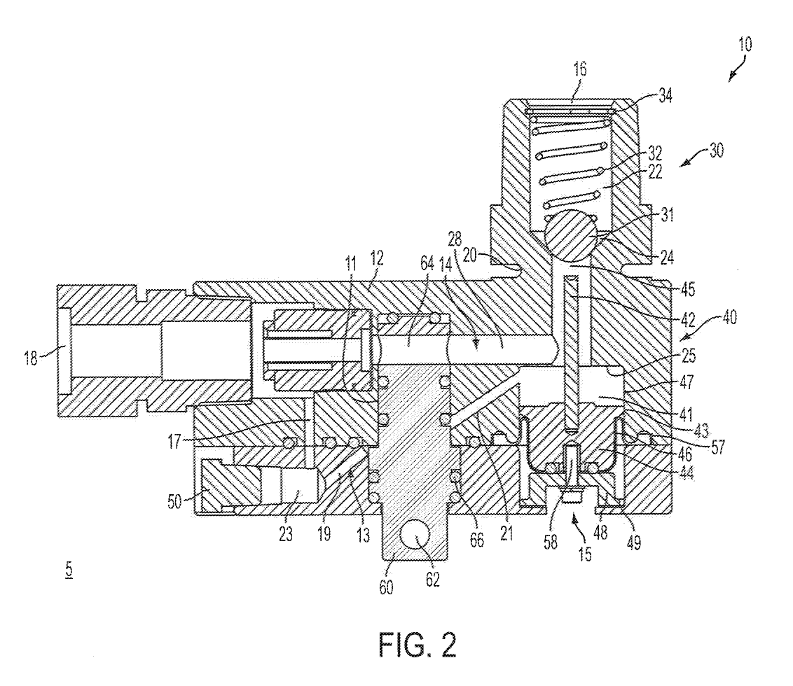

Referring to FIGS. 1 and 2, a first embodiment of a valve assembly 10 will be described.

The valve assembly 10 comprises a body 12 having a primary passageway 14 (shown in dark grey in FIG. 2) defined therethrough between an inlet 16 and an outlet 18. The body 12 is made of aluminum. It is contemplated that the body 12 could be made of bronze, brass, steel, or any other material based on the type of fluid in process. The body 12 has a secondary passageway 13 (shown in light grey in FIG. 2) which is fluidly isolated from the primary passageway 14. The primary passageway 14 and the secondary passageway 13 will be described in detail below. The body 12 includes a neck 20 which is used as a breakoff assembly, as will be described below.

The valve assembly 10 is adapted to connect to a fluid source at the inlet 16. The source is a reservoir (not shown) of gas. It is contemplated that the source could be a tank or reservoir of a liquid, such as fuel. The valve assembly 10 is adapted to connect to a fluid recipient device (not shown) at the outlet 18. The fluid recipient device is connected to the valve assembly 10 via a pipe 4 (shown in phantom lines in FIG. 1). The pipe 4 includes an inner fluid line 6 and a coaxial outer fluid line 7 (also shown in phantom lines in FIG. 1). The outer fluid line 7 is disposed around the inner fluid line 6 and is filled with a gas at a pressure different from the one of the inner fluid line 6. In the embodiment shown in FIGS. 1 and 2, the inner fluid line 6 has a pressure higher than the outer fluid line 7 and the outer fluid line 7 is under vacuum. It is contemplated that the outer fluid line 7 could not be at vacuum, as long as the inner fluid line 6 has a pressure higher than the outer fluid line 7. In the embodiment described in FIGS. 1 and 2, the outer fluid line 7 has also a pressure lower than a pressure of a surrounding environment 5, which in the embodiment shown herein is at atmospheric pressure.

The inner fluid line 6 fluidly connects to the primary passageway 14, while the outer fluid line 7 fluidly connects to the secondary passageway 13. As such, in normal operation, the outer fluid line 7 and the inner fluid line 6 do not communicate with each other.

Progressing from the inlet 16 to the outlet 18, the primary passageway 14 includes an upper vertical passageway 22, an angled passageway 24, a narrowed vertical passageway 26, and an horizontal passageway 28. Although the upper passageway 22 is shown herein as having a cylindrical shape, other shapes are also contemplated. A bottom of the upper passageway 22 connects to the vertical angled passageway 24. The angled passageway 24 is cone shaped to provide a valve seat to a valve member 30. The valve member 30 will be described below. It is contemplated that the valve assembly 10 could include more than one valve member 30.

The narrowed vertical passageway 26 extends downwardly from the bottom of the angled passageway 24. The narrowed passageway 26 is cylindrical with a diameter equal to that of the outlet of the angled passageway 24. It is contemplated that the narrowed passageway 26 could have a shape other than the one shown and described herein. For example, the narrowed passageway 26 could be square. The narrowed passageway 26 connects to the horizontal passageway 28 at a bottom thereof. The horizontal passageway 28 is cylindrical and has a diameter equal to the one of the narrowed passageway 26. It is contemplated that the horizontal passageway 28 could have a diameter greater or smaller than the one of the passageway 26. The horizontal passageway 28 includes a portion defined in a manual cut-off valve 60. The manual cut-off valve 60 will be described below.

The secondary passageway 13 includes a vertical passageway 17 and oblique passageways 19 and 21. The vertical passageway 17 is in communication with the outer fluid line 7 on one end and with a chamber 23 on the other end. The chamber 23 is sealed by a fusible plug 50, which will described below. The chamber 23 connects to the first oblique passageway 19. The first oblique passageway 19 is connected to the second oblique passageway 21 by a connection not visible on FIGS. 1 and 2. The second oblique passageway 21 communicates with an upper chamber 41 which has a variable volume. As a result, a volume of the upper chamber 41 depends on a pressure of the outer fluid line 7.

The valve member 30 includes a ball 31 and a spring 32. The ball 31 which is disposed within the vertical passageways 22, 24, is movable between an open position (shown in FIG. 1) where the ball 31 is disposed away from the angled passageway 24 and where fluid is allow to flow around the ball 31 from the inlet 16 to the outlet 18, and a closed position (shown in FIG. 2) where the ball 31 is in abutment with the angled passageway 24 and where fluid is prevented to flow around the ball 31 through the passageway 24 toward the outlet 18. The spring 32 biases the ball 31 towards the closed position. The shape of the ball 31 and the angled passageway 24 need not be of circular cross section and may be varied as long as the valve member is movable to close the passageway it is disposed in. A spring washer 34 and a spring retaining ring (not shown) are disposed above the spring 32. The spring retaining ring snaps into a recessed ring (not shown) in the body 12 to connect the spring 32 to the body 12. The spring 32 is compressible between the spring washer 34 and the ball 31. Fluid can flow through the spring 32, the spring retaining ring and the spring washer 34. It is contemplated that a biasing member other than the spring 32 could be used for biasing the ball 31 towards the closed position. The diameter of the bottom of the angled passageway 24 is smaller than a diameter of the ball 31, and a diameter of the upper passageway 22 is greater than the diameter of the ball 31 so that fluid may flow through the upper passageway 22 around the ball 31.

The ball 31 is supported by a piston rod 42 which is connected a piston assembly 40. The piston assembly 40 includes from the piston rod 42 downwards, an upper piston 44, a diaphragm 46, and a lower piston 48. The piston assembly 40 is movable between an upper position (shown in FIG. 1) where the piston assembly 40 forces the valve assembly 30 in the open position and a lower position (shown in FIG. 2) where the piston assembly 40 forces the valve assembly 30 in the closed position depending of a pressure of the fluid contained in the upper chamber 41 (i.e. a pressure of the outer fluid line 7). The upper chamber 41 is shown in FIG. 2.

The upper chamber 41 is defined between an upper wall 25, a piston cylinder 47, and the upper piston 44. The oblique passageway 21 connects the upper chamber 41 to the outer fluid line 7. Therefore, when the valve member 30 is in the closed position (i.e. when pressure in the secondary passageway 13 is higher than pressure in the primary passageway 14), the upper chamber 41 is expanded, the piston assembly 40 moves downward, and the ball 31 abuts the angular passageway 24. When the valve member 30 is in the open position (i.e. when pressure in the secondary passageway 13 is lower than pressure in the primary passageway 14), a volume of the upper chamber 41 is reduced, the piston assembly 40 moves upwardly and the ball 31 is disposed away from the angular passageway 24.

The piston rod 42 abuts an underside of the ball 31 opposite to the biasing spring 32. The piston rod 42 is press fit into the upper piston 44, which is disposed vertically below the piston rod 42. The upper piston 44 is movable vertically within the piston cylinder 47, so that when the upper piston 44 is in the lower position of the piston assembly 40, a gap 45 (shown in FIG. 2) is formed between the piston rod 42 and the ball 31. It is contemplated that the valve assembly 10 could be designed so that the ball 31 could be fixedly connected to the piston rod 42, and that when the upper piston 44 is in the lower position of the piston assembly 40, no gap 45 could be formed between the piston rod 42 and the ball 31 but still the valve member 30 would accomplish its task. It is also contemplated that the piston rod 42 be fixedly connected to the ball 31 and that the spring 32 could be omitted. An outer circumference of the upper piston 44 has a shoulder 43 so that the upper piston 44 has a diameter sized to match a diameter of the piston cylinder 47. A bottom of the upper piston 44 receives a screw 58 for connecting the upper piston 47 to the lower piston 48.

The diaphragm 46 prevents fluid communication between the primary passageway 14 and the secondary passageway 13, should fluid escape on sides of the upper and lower pistons 44, 48 toward the upper chamber 41. The diaphragm 46 is circular, flexible and has a hole in the middle to receive the screw 58. The diaphragm 46 is sandwiched in part between the upper piston 44 and the lower piston 48. The diaphragm 46 also has a thick rim (not shown) around its circumference. The rim of the diaphragm 46 is inserted into a recess 57.

The lower piston 48 has an inverted cup shape with an outwardly extending shoulder 49 so that the lower piston 48 has a diameter sized to match a diameter of the piston cylinder 47. The lower piston 48 has a hole (not shown) through the middle to receive the screw 58. A flat washer and a lock washer (both not shown) are placed over the screw 58 which holds the pistons 44 and 48 and diaphragm 46 together. The connection is fluid tight so that no fluid can move through the centre hole in the diaphragm 46 for connecting securely the diaphragm 46 to the body 12. The body 12 includes an opening 15 disposed vertically below the lower piston 48 so that an outside of the lower piston 48 is in contact with the environment 5. It is contemplated that the opening 15 could instead connect to the inner fluid line 6 or any other fluid line where the pressure is higher than the pressure of the outer fluid line 7.

Although a particular piston assembly 40 and valve member 30 have been described, it should be understood that other piston assemblies, valve members and other shapes of components may be provided. For example, the lower piston 48 may be flattened. In another example, a shape of the upper piston 44 may be altered. In yet another example, a single piston rather than two pistons 44 and 48 may be used. In yet another example, the diaphragm 46 may be removed and the pistons 44, 48 sealed to the cylinder in a fluid tight manner.

The manual cut-off valve 60 will now be described. The manual cut-off valve 60 includes a rubber plug 62 having a horizontal bore 64 extending therethrough. The manual cut-off valve 60 is sealed to the body 12 by a plurality of O-rings 66 (only one being shown to avoid cluttering the drawings). The manual cut-off valve 60 is rotatable along a vertical axis 61 (shown in FIG. 1) so as to position the bore 64 between a first position where the bore 64 is aligned with the primary passageway 14 (shown in FIGS. 1 and 2) and a second position where the bore 64 is at an angle relative to the primary passageway 14 and fluid communication is interrupted between the inlet 16 and the outlet 18. The manual cut-off valve 60 is operable via an opening 68 disposed at an end of the manual cut-off valve 60 opposite to the bore 64, such that a tool can be inserted into the opening 68 to facilitate rotation of the manual cut-off valve 60 around the vertical axis 61. Such tool could, for example, be a screw driver. The opening 68 could be omitted or replaced by another facilitating rotation of the plug 60. The manual cut-off valve 60 is disposed within a cavity 11 of the body 12 which is in fluid communication with the passageways 13, 14. When the manual cut-off valve 60 is within the cavity 11, whether it is in the first or second position, the passageways 13, 14 are isolated from the environment 5. However, when the manual cut-off valve 60 is removed from the cavity 11, the passageways 13, 14 becomes in contact with the environment 5 which affects a pressure within the outer fluid line 7. Thus, the manual cut-off valve 60 may be used as an emergency trigger whereby pulling the manual cut-off valve 60 out of the body 12 triggers one of the safety modes described below by inducing a change of pressure in the outer fluid line 7. It is contemplated that the manual cut-off valve 60 could be omitted.

The fusible plug 50 is disposed at en end of the chamber 23 which, as described above, is in fluid communication with the outer fluid line 7. The fusible plug 50 is adapted to melt at a predetermined temperature of 165° C. (329° F.). Such temperatures could be reached in the case, for example, of a fire. As a consequence, the fusible plug 50 may serve as safety for the valve assembly 10. It is contemplated that the fusible plug 50 could melt at temperatures other than 165° C. It is also contemplated that the fusible plug 50 could be omitted.

Under normal operation (as shown in FIG. 1), the outer flow line 7 is not in fluid communication with the inner flow line 6, and the valve assembly 10 remains in the open position until it moves to the closed position in response to one or more of the following modes of failure. These safety modes allow to close the primary passageway 14 when either or the inner fluid line 6 and the outer fluid line 7 is leaking or ruptured.

In a first safety mode, if the inner fluid line 6 leaks into the outer fluid line 7, pressure in the secondary passageway 13 increases (since under normal conditions the outer fluid line 7 has a pressure lower than the inner fluid line 6), which will increase the volume of the upper chamber 41, thereby moving the ball 31 toward the passageway 24 and interrupting fluid communication in the primary passageway 14.

In a second safety mode, if the outer fluid line 7 leaks and becomes in contact with the environment 5. Since the environment 5 has a pressure higher than the outer fluid line 7, pressure in the secondary passageway 13 increases, which will increase the volume of the upper chamber 41, thereby moving the ball 31 toward the passageway 24 and interrupting fluid communication in the primary passageway 14.

In a third safety mode, if the valve assembly 10 is broken at the neck 20 (e.g. when struck with a shearing force), a pressure of a portion of the primary passageway 14 ahead of the ball 31 will be greater than a pressure of a portion of the primary passageway 14 after of the ball 31. As a result, the biasing spring 32 will move the ball 31 downwards toward the passageway 24, thereby closing the primary passageway 14. In some cases, a complete shearing of the neck 20 may cause the body 12 to break into two portions. In such event, the valve assembly 10 will close by having the ball 31 abut the passageway 24.

In a fourth safety mode, an emergency closing of the valve assembly 10 can be achieved by pulling the manual cut-off valve 60 out of the body 12. By doing so, the inner fluid line 6 becomes in contact with the environment 5 and the outer fluid line 7, pressure in the secondary passageway 13 increases, which will increase the volume of the upper chamber 41, thereby moving the ball 31 toward the passageway 24.

In a fifth safety mode, an emergency closing of the valve assembly 10 can be achieved by rotating the manual cut-off valve 60 so that the bore 64 is angled with respect to the primary passageway 14, thereby closing the primary passageway 14.

In a sixth safety mode, the fusible plug 50 melts at least partially if temperature exceeds the predetermined temperature, thereby allowing communication between the secondary passageway 13 with the environment 5. As a result, pressure in the secondary passageway 13 increases, which increases the volume of the upper chamber 41, thereby moving the ball 30 toward the passageway 24.

It is contemplated that the valve assembly 10 could have more or less safety modes than the ones recited above.

To install the valve assembly 10, the valve assembly 10 is first positioned in the closed position shown in FIG. 2 with the ball 31 seated in the angled passageway 24 by the expansion force of the compressed spring 32 to prevent fluid flow through the primary passageway 14 and by having the piston rod 42 in a lower position away from the ball 31. The valve assembly 10 is then connected to the reservoir at the inlet 16 and to the inner fluid line 6 of the pipe at the outlet 18. When the above connections are made, the passageway 14 is fluid tight from the reservoir to the pipe 4. The secondary passageway 13 is then connected to the outer flow line 7. Vacuum is then made in the outer fluid line 7. Decrease in pressure in the outer fluid line 7 reduces a volume of the upper chamber 41, thereby pushing the pistons 44 and 48 upward which in turn move the piston rod 42 upward. The piston rod 42 pushes the ball 31 upward, compressing the spring 32 and lifting the ball 31 out of contact with the angled passageway 24 to open the passageway 14. The pistons 44 and 48 move upward by the increasing pressure until the upper piston 44 contact an abutting wall 25 defined in the body 12.

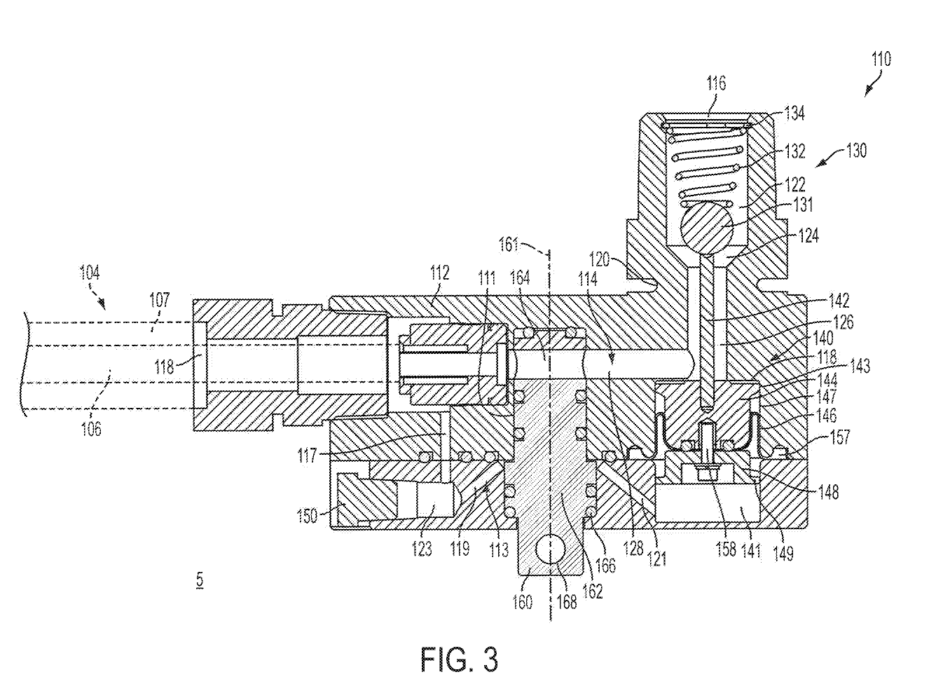

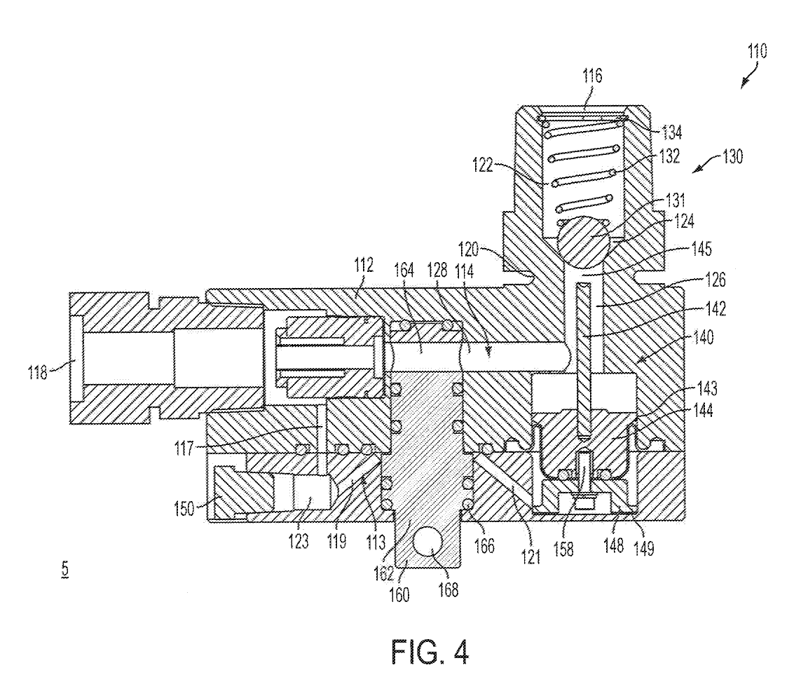

Turning now to FIGS. 3 and 4, a valve assembly 110 according to a second embodiment will be described.

The valve assembly 110 has components similar to the ones of the valve assembly 100. Such components will have same references numerals as the ones of the valve assembly 10 but in the hundred range. The second embodiment of the valve assembly 110 differs from the first embodiment of the valve assembly 10 in that the valve assembly 110 allows to receive a fluid in the inner fluid line at a pressure lower than the fluid of the outer fluid line. As such, a chamber disposed below the piston assembly (as opposed to the upper chamber 41) is in communication with the secondary passageway.

The valve assembly 110 comprises a body 112 having a primary passageway 114 defined therethrough between an inlet 116 and an outlet 118. The body 112 is made of aluminum. It is contemplated that the body 112 could be made of bronze, brass, steel, or any other material based on the type of fluid in process. The body 112 has a secondary passageway 113 which is fluidly isolated from the primary passageway 114. The primary passageway 114 and the secondary passageway 113 will be described in detail below. The body 112 includes a neck 120 which is used as a breakoff assembly, as will be described below.

The valve assembly 110 is adapted to connect to a fluid source at the inlet 116. The source is a reservoir (not shown) of gas. It is contemplated that the source could be a tank or reservoir of a liquid, such as fuel. The valve assembly 110 is adapted to connect to a fluid recipient device (not shown) at the outlet 118. The fluid recipient device is connected to the valve assembly 110 via a pipe 104 (shown in phantom lines in FIG. 3). The pipe 104 includes an inner fluid line 106 and a coaxial outer fluid line 107 (also shown in phantom lines in FIG. 3). The outer fluid line 107 is disposed around the inner fluid line 106 and is filled with a gas at a pressure different from the one of the inner fluid line 106. In the embodiment shown in FIGS. 3 and 4, the inner fluid line 106 has a pressure lower than the outer fluid line 107. In the embodiment described in FIGS. 3 and 4, the outer fluid line 107 has also a pressure higher than a pressure of a surrounding environment 105, which in the embodiment shown herein is at atmospheric pressure.

The inner fluid line 106 fluidly connects to the primary passageway 114, while the outer fluid line 107 fluidly connects to the secondary passageway 113. As such, in normal operation, the outer fluid line 107 and the inner fluid line 106 do not communicate with each other.

Progressing from the inlet 116 to the outlet 118, the primary passageway 114 includes an upper vertical passageway 122, an angled passageway 124, a narrowed vertical passageway 126, and an horizontal passageway 128. Although the upper passageway 122 is shown herein as having a cylindrical shape, other shapes are also contemplated. A bottom of the upper passageway 122 connects to the vertical angled passageway 124. The angled passageway 124 is cone shaped to provide a valve seat to a valve member 130. The valve member 130 will be described below. It is contemplated that the valve assembly 110 could include more than one valve member 130.

The narrowed vertical passageway 126 extends downwardly from the bottom of the angled passageway 124. The narrowed passageway 126 is cylindrical with a diameter equal to that of the outlet of the angled passageway 124. It is contemplated that the narrowed passageway 126 could have a shape other than the one shown and described herein. For example, the narrowed passageway 126 could be square. The narrowed passageway 126 connects to the horizontal passageway 128 at a bottom thereof. The horizontal passageway 128 is cylindrical and has a diameter equal to the one of the narrowed passageway 126. It is contemplated that the horizontal passageway 128 could have a diameter greater or smaller than the one of the passageway 126. The horizontal passageway 128 includes a portion defined in a manual cut-off valve 160. The manual cut-off valve 160 will be described below.

The secondary passageway 113 includes a vertical passageway 117 and oblique passageways 119 and 121. The vertical passageway 117 is in communication with the outer fluid line 107 on one end and with a chamber 123 on the other end. The chamber 123 is sealed by a fusible plug 150, which will described below. The chamber 123 connects to the first oblique passageway 119. The first oblique passageway 119 is connected to the second oblique passageway 121 by a connection not visible on FIGS. 3 and 4. The second oblique passageway 121 communicates with a lower chamber 141 which has a variable volume. As a result, a volume of the lower chamber 141 depends on a pressure of the outer fluid line 107.

The valve member 130 includes a ball 131 and a spring 132. The ball 131 which is disposed within the vertical passageways 122, 124, is movable between an open position (shown in FIG. 3) where the ball 131 is disposed away from the angled passageway 124 and where fluid is allow to flow around the ball 131 from the inlet 116 to the outlet 118, and a closed position (shown in FIG. 4) where the ball 131 is in abutment with the angled passageway 124 and where fluid is prevented to flow around the ball 131 through the passageway 124 toward the outlet 118. The spring 132 biases the ball 131 towards the closed position. The shape of the ball 131 and the angled passageway 124 need not be of circular cross section and may be varied as long as the valve member is movable to close the passageway it is disposed in. A spring washer 134 and a spring retaining ring (not shown) are disposed above the spring 132. The spring retaining ring snaps into a recessed ring (not shown) in the body 112 to connect the spring 132 to the body 112. The spring 132 is compressible between the spring washer 134 and the ball 131. Fluid can flow through the spring 132, the spring retaining ring and the spring washer 134. It is contemplated that a biasing member other than the spring 132 could be used for biasing the ball 131 towards the closed position. The diameter of the bottom of the angled passageway 124 is smaller than a diameter of the ball 131, and a diameter of the upper passageway 122 is greater than the diameter of the ball 131 so that fluid may flow through the upper passageway 122 around the ball 131.

The ball 131 is supported by a piston rod 142 which is connected a piston assembly 140. The piston assembly 140 includes from the piston rod 142 downwards, an upper piston 144, a diaphragm 146, and a lower piston 148. The piston assembly 140 is movable between an upper position (shown in FIG. 3) where the piston assembly 140 forces the valve assembly 130 in the open position and a lower position (shown in FIG. 4) where the piston assembly 140 forces the valve assembly 130 in the closed position depending of a pressure of the fluid contained in the lower chamber 141 (i.e. a pressure of the outer fluid line 107). The upper chamber 141 is shown in FIG. 3.

The lower chamber 141 is defined between a lower wall 125, a piston cylinder 147, and the lower piston 148. The oblique passageway 121 connects the lower chamber 141 to the outer fluid line 107. Therefore, when the valve member 130 is in the closed position (i.e. when pressure in the secondary passageway 113 is lower than pressure in the primary passageway 114), the lower chamber 141 is retracted, the piston assembly 140 moves downward, and the ball 131 abuts the angular passageway 124. When the valve member 130 is in the open position (i.e. when pressure in the secondary passageway 113 is higher than pressure in the primary passageway 114), a volume of the lower chamber 141 increases, the piston assembly 140 moves upwardly and the ball 131 is disposed away from the angular passageway 124.

The piston rod 142 abuts an underside of the ball 131 opposite to the biasing spring 132. The piston rod 142 is press fit into the upper piston 144, which is disposed vertically below the piston rod 142. The upper piston 144 is movable vertically within the piston cylinder 147, so that when the upper piston 144 is in the lower position of the piston assembly 140, a gap 145 (shown in FIG. 4) is formed between the piston rod 142 and the ball 131. It is contemplated that the valve assembly 110 could be designed so that the ball 131 could be fixedly connected to the piston rod 142, and that when the upper piston 144 is in the lower position of the piston assembly 140, no gap 145 could be formed between the piston rod 142 and the ball 131 but still the valve member 130 would accomplish its task. It is also contemplated that the piston rod 142 be fixedly connected to the ball 131 and that the spring 132 could be omitted. An outer circumference of the upper piston 144 has a shoulder 143 so that the upper piston 144 has a diameter sized to match a diameter of the piston cylinder 47. A bottom of the upper piston 144 receives a screw 158 for connecting the upper piston 147 to the lower piston 148.

The diaphragm 146 prevents fluid communication between the primary passageway 114 and the secondary passageway 113, should fluid escape on sides of the upper and lower pistons 144, 148 toward the lower chamber 141. The diaphragm 146 is circular, flexible and has a hole in the middle to receive the screw 158. The diaphragm 146 is sandwiched in part between the upper piston 144 and the lower piston 148. The diaphragm 146 also has a thick rim (not shown) around its circumference. The rim of the diaphragm 146 is inserted into a recess 157.

The lower piston 148 has an inverted cup shape with an outwardly extending shoulder 149 so that the lower piston 148 has a diameter sized to match a diameter of the piston cylinder 147. The lower piston 148 has a hole (not shown) through the middle to receive the screw 158. A flat washer and a lock washer (both not shown) are placed over the screw 158 which holds the pistons 144 and 148 and diaphragm 146 together. The connection is fluid tight so that no fluid can move through the centre hole in the diaphragm 146 for connecting securely the diaphragm 146 to the body 112.

Although a particular piston assembly 140 and valve member 130 have been described, it should be understood that other piston assemblies, valve members and other shapes of components may be provided. For example, the lower piston 148 may be flattened. In another example, a shape of the upper piston 144 may be altered. In yet another example, a single piston rather than two pistons 144 and 148 may be used. In yet another example, the diaphragm 146 may be removed and the pistons 144, 148 sealed to the cylinder in a fluid tight manner.

The manual cut-off valve 160 will now be described. The manual cut-off valve 160 includes a rubber plug 162 having a horizontal bore 164 extending therethrough. The manual cut-off valve 160 is sealed to the body 112 by a plurality of O-rings 166 (only one being shown to avoid cluttering the drawings). The manual cut-off valve 160 is rotatable along a vertical axis 161 (shown in FIG. 3) so as to position the bore 164 between a first position where the bore 164 is aligned with the primary passageway 114 (shown in FIGS. 3 and 4) and a second position where the bore 164 is at an angle relative to the primary passageway 114 and fluid communication is interrupted between the inlet 116 and the outlet 118. The manual cut-off valve 160 is operable via an opening 168 disposed at an end of the manual cut-off valve 160 opposite to the bore 164, such that a tool can be inserted into the opening 168 to facilitate rotation of the manual cut-off valve 160 around the vertical axis 161. Such tool could, for example, be a screw driver. The opening 168 could be omitted or replaced by another facilitating rotation of the plug 160. The manual cut-off valve 160 is disposed within a cavity 111 of the body 112 which is in fluid communication with the passageways 113, 114. When the manual cut-off valve 160 is within the cavity 11, whether it is in the first or second position, the passageways 113, 114 are isolated from the environment 105. However, when the manual cut-off valve 160 is removed from the cavity 11, the passageways 113, 114 becomes in contact with the environment 105 which affects a pressure within the outer fluid line 107. Thus, the manual cut-off valve 160 may be used as an emergency trigger whereby pulling the manual cut-off valve 160 out of the body 112 triggers one of the safety modes described below by inducing a change of pressure in the outer fluid line 107. It is contemplated that the manual cut-off valve 160 could be omitted.

The fusible plug 150 is disposed at en end of the chamber 123 which, as described above, is in fluid communication with the outer fluid line 107. The fusible plug 150 is adapted to melt at a predetermined temperature of 165° C. (329° F.). Such temperatures could be reached in the case, for example, of a fire. As a consequence, the fusible plug 150 may serve as safety for the valve assembly 110. It is contemplated that the fusible plug 150 could melt at temperatures other than 165° C. It is also contemplated that the fusible plug 150 could be omitted.

Under normal operation, the outer flow line 107 is not in fluid communication with the inner flow line 106, and the valve assembly 110 remains in the open position until it moves to the closed position in response to one or more of the following modes of failure.

In a first safety mode, if the inner fluid line 106 leaks into the outer fluid line 107, pressure in the secondary passageway 113 decreases (since the outer fluid line 107 has a pressure higher than the inner fluid line 106), which will reduce the volume of the lower chamber 141, thereby moving the ball 131 toward the passageway 124.

In a second safety mode, if the outer fluid line 107 leaks and becomes in contact with the environment 5, pressure in the secondary passageway 113 decreases (since the outer fluid line 107 has a pressure higher than the environment 5), which will reduce the volume of the lower chamber 141, thereby moving the ball 131 toward the passageway 124.

In a third safety mode, if the valve assembly 110 is broken at the neck 120 (e.g. when struck with a shearing force), a pressure of a portion of the primary passageway 114 ahead of the ball 131 becomes greater than a pressure of a portion of the primary passageway 114 after of the ball 131. As a result, the biasing spring 132 moves the ball 131 downwards toward the passageway 124, thereby closing the primary passageway 114. In some cases, a complete shearing of the neck 120 may cause the body 112 to break into two portions. In such event, the valve assembly 110 will close by having the ball 131 abut the passageway 124.

In a fourth safety mode, an emergency closing of the valve assembly 110 can be achieved by pulling the manual cut-off valve 160 out of the body 112. By doing so, the inner fluid line 106 becomes in contact with the environment 5 and the outer fluid line 107, pressure in the secondary passageway 113 decreases, which reduces the volume of the lower chamber 141, thereby moving the ball 131 toward the passageway 124.

In a fifth safety mode, an emergency closing of the valve assembly 110 can be achieved by rotating the manual cut-off valve 160 so that the bore 164 is angled with respect to the primary passageway 114, thereby closing the primary passageway 114.

In a sixth safety mode, the fusible plug 150 melts at least partially if temperature exceeds the predetermined temperature, thereby allowing communication between the secondary passageway 113 with the environment 5. As a result, pressure in the secondary passageway 113 decreases, which reduces the volume of the lower chamber 41, thereby moving the ball 131 toward the passageway 124.

It is contemplated that the valve assembly 110 could have more or less safety modes than the ones recited above.

To install the valve assembly 110, the valve assembly 110 is first positioned in the closed position shown in FIG. 1 with the ball 131 seated in the angled passageway 124 by the expansion force of the compressed spring 132 to prevent fluid flow through the primary passageway 114. The valve assembly 110 is then connected to the reservoir at the inlet 116 and to the inner fluid line 106 of the pipe at the outlet 118. When the above connections are made, the passageway 114 is fluid tight from the reservoir to the pipe 104. The secondary passageway 113 is then connected to the outer flow line 107. The outer fluid line 107 having a pressure higher than the inner fluid line 6, as the fluid populates the outer flow line 107 (also known as “surveillance fluid”), the increase in pressure in the lower chamber 141 pushes the pistons 144 and 148 upward which in turn move the piston rod 142 upward. The piston rod 142 pushes the ball 131 upward, compressing the spring 132 and lifting the ball 131 out of contact with the angled passageway 124 to open the passageway 114. The pistons 144 and 148 move upward by the increasing pressure until the shoulder 43 of the upper piston 144 contacts an abutting wall 125 defined in the body 112.

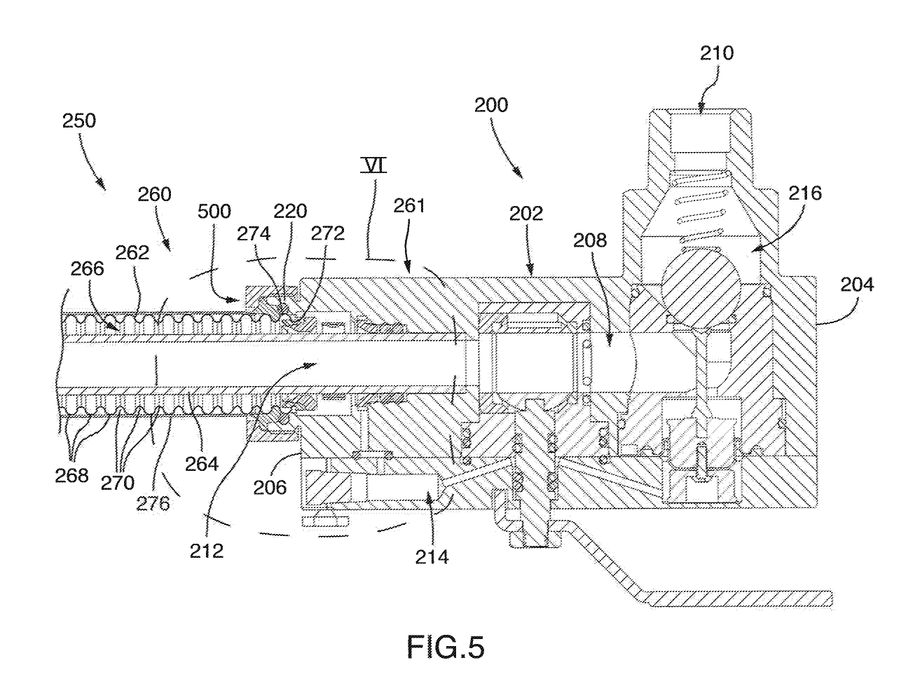

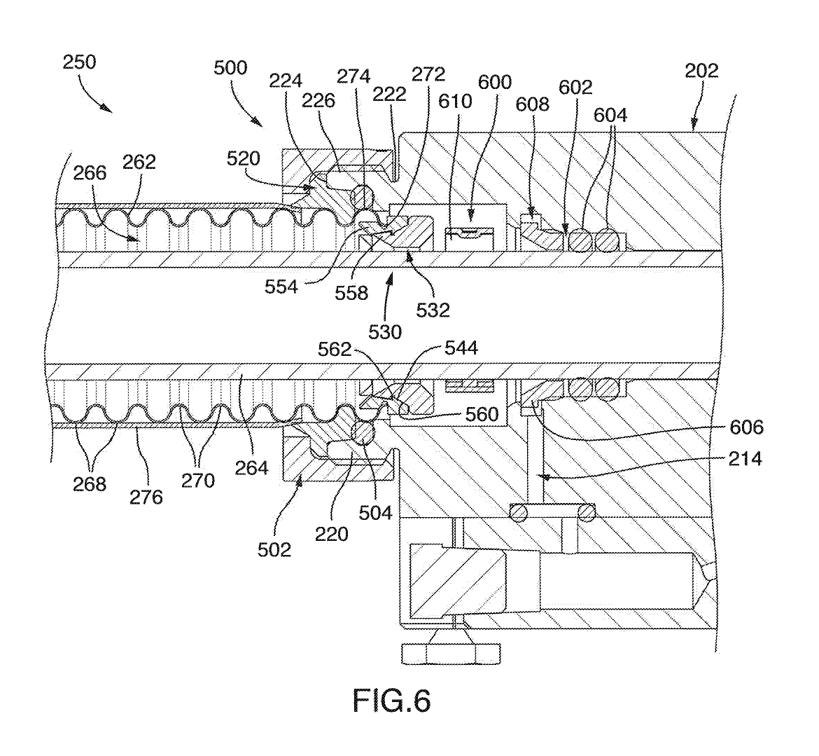

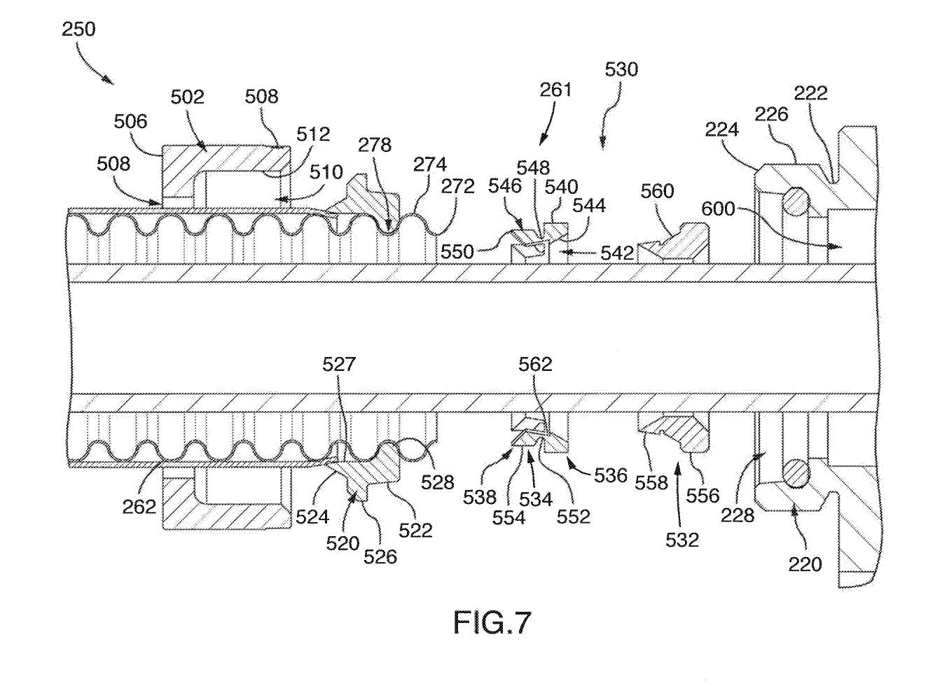

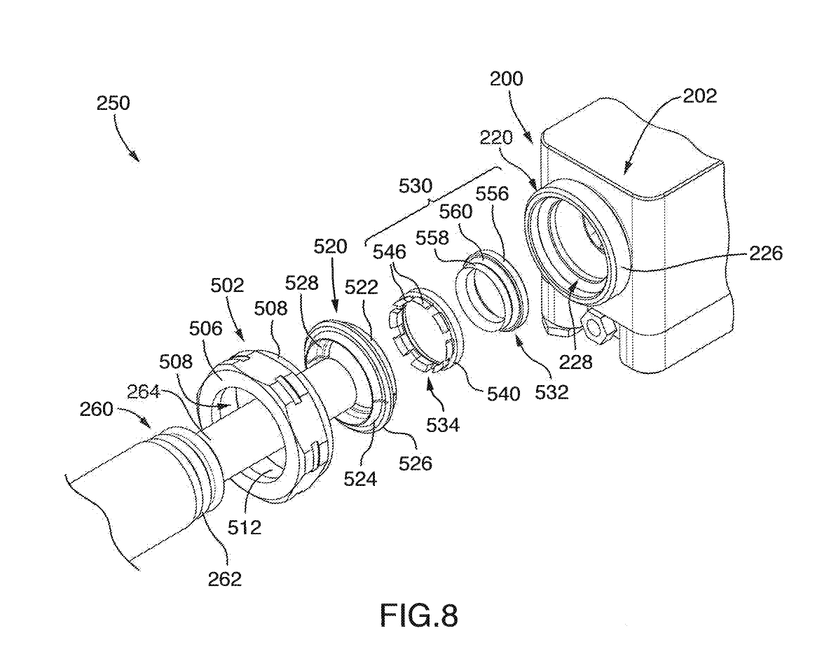

Now turning to FIGS. 5 to 8, there is shown a valve assembly 200, in accordance with yet another embodiment. The valve assembly 200 is generally similar to the valve assembly 110 illustrated in FIGS. 3 and 4. The valve assembly 200 is part of a valve system 250, which includes the valve assembly 200 and a pipe 260 which is adapted for connecting the valve assembly 200 to a fluid recipient device (not shown). Specifically, the pipe 260 has a first end 261 adapted to be connected to the valve assembly 200 and a second end (not shown) adapted to be connected to the fluid recipient device.

In the embodiment illustrated in FIGS. 5 to 8, the pipe 260 is a double-walled pipe, similarly to the pipe 104 shown in FIG. 3. More specifically, the pipe 260 comprises an outer sidewall 262 having a first diameter and an inner sidewall 264 having a second diameter smaller than the first diameter. The inner and outer sidewall 264, 262 both have a circular cross-section and the inner sidewall 264 is disposed coaxially within the outer sidewall 262. The inner sidewall 264 is therefore spaced radially inwardly from the outer sidewall 262 to define an annular interstitial space 266 between the inner sidewall 264 and the outer sidewall 262. In the illustrated embodiment, the inner sidewall 264 forms a central conduit 267 which defines an inner fluid line and the interstitial space 266 between the inner sidewall 264 and the outer sidewall 262 defines an outer fluid line which is disposed around the inner fluid line.

Still in the embodiment illustrated in FIGS. 5 to 8, the outer fluid line is filled with a fluid at a pressure different from the fluid in the inner fluid line. Specifically, the inner fluid line has a pressure lower than the outer fluid line. In the embodiment illustrated in FIGS. 5 to 8, the outer fluid line has also a pressure higher than a pressure of a surrounding environment, which in the embodiment shown herein is at atmospheric pressure.

Still in this embodiment, the outer sidewall 262 of the pipe 260 is corrugated. More specifically, the outer sidewall 262 includes a plurality of annular ribs 268 spaced apart from each other by a plurality of annular grooves 270. The pipe 260 may be manufactured by cutting a longer piece of pipe to a desired length. In the embodiment illustrated in FIGS. 5 to 8, the first end 261 of the pipe 260 has a rim 272 formed by a half of one of the annular grooves 270 and the plurality of annular ribs 268 includes a first annular rib 274 adjacent the rim 272.

The pipe 260 may further be provided with a sheath 276 disposed over the outer sidewall 262 to mask the annular ribs 268 and grooves 270 of the outer sidewall 262. The sheath 276 may be smooth or have any other configuration. Alternatively, instead of a smooth sheath being provided, the outer sidewall 262 itself could instead be smooth or have any other desired pattern or texture.

Still referring to FIGS. 5 to 8, the valve assembly 200 comprises a body 202 having a first end 204 and a second end 206. A primary passageway 208 is further defined through the body 202 between a first end or inlet 210 adapted to be connected to a fluid source (not shown) and a second end or outlet 212 adapted to be connected to the central conduit 267 of the pipe 260.

In the illustrated embodiment, a secondary passageway 214 is further defined in the body 202. The secondary passageway 214 is located adjacent the primary passageway 208 and is adapted to be connected to the interstitial space 266 of the pipe 260. The secondary passageway 214 is fluidly isolated from the primary passageway 208 such that, during normal operation of the valve assembly 200, the outer fluid line and the inner fluid line do not communicate with each other.

Still in the embodiment illustrated in FIGS. 5 to 8, the primary and secondary passageways 208, 214 are generally similar to the primary and secondary passageways 114, 113 of the valve assembly 110 illustrated in FIGS. 3 and 4. The primary and secondary passageways 208, 214 therefore need not be described in further detail.

The valve assembly 200 further comprises a valve or valve member 216 which is disposed in the primary passageway 208 between the inlet 210 and the outlet 212. The valve member 216 is generally similar to the valve member 130 of the valve assembly 110 illustrated in FIGS. 3 and 4. Similarly to the valve member 130 of the valve assembly 110, the valve member 216 is movable between a first position in which the primary passageway 208 is open and fluid communicates between the inlet 210 and the outlet 212, and a second position in which the primary passageway 208 is closed and fluid is prevented from communicating between the inlet 210 and the outlet 212 of the primary passageway 208. The valve member 216 is adapted to be movable between the first and second positions in response to the pressure in the secondary passageway 214. For example, if the inner fluid line leaks into the outer fluid line, pressure in the secondary passageway 214 decreases (since the outer fluid line has a pressure higher than the inner fluid line), which will move the valve member 216 from the first position towards the second position, thereby closing the valve assembly 200. In another example, if the outer fluid line leaks and becomes in contact with the environment, pressure in the secondary passageway 214 decreases (since the outer fluid line has a pressure higher than the environment), which will also move the valve member 216 from the first position towards the second position, thereby closing the valve assembly 200.

In the embodiment illustrated in FIGS. 5 to 8, the valve assembly 200 further comprises a coupling assembly 500 for sealingly connecting the body 202 to the pipe 250. Specifically, the body 202 further includes a tubular connector 220 extending away from the second end 206 of the body 202, and the coupling assembly 500 is adapted for engaging the tubular connector 220. More specifically, the tubular connector 220 has a first connector end 222 which is connected to the second end 206 of the body 202 and a second connector end 224 which is located away from the second end 206 of the body 202. Still in the illustrated embodiment, the tubular connector 220 further includes a threaded outer surface 226 for connecting the pipe 260 to the body 202, as will be explained further below.

Still in the illustrated embodiment, the tubular connector 220 and the body 202 of the valve assembly 200 are integrally formed together to define a unitary body. Alternatively, the tubular connector 220 and the body 202 could be provided as two distinct components and assembled together using means known to the skilled addressee such as welding or the like.

As illustrated in FIG. 5, the primary passageway 208 extends through the body 202 of the valve assembly 200 and through the tubular connector 220. Specifically, the inlet 210 of the primary passageway 208 coincides with the first end 204 of the body 202 and the outlet 212 coincides with the second connector end 224 of the tubular connector 220.

Still referring to FIGS. 5 to 8, the coupling assembly 500 comprises an annular compression 502 member and an O-ring seal 504 which are both adapted to be disposed concentrically around the pipe 260.

In the embodiment illustrated in FIGS. 5 to 8, the annular compression member 502 has a shape generally similar to that of a screw cap and comprises a closed end portion 506 having a circular central opening 508 sized and shaped to snuggly receive the pipe's outer sidewall 262 and an open end portion 508 comprising a circular recess 510 in which is defined a threaded inner side surface 512. The threaded inner surface 512 has an inner diameter generally corresponding to the outer diameter of the tubular connector 220 and has threads corresponding to the threads of the threaded outer surface 226 of the tubular connector 220 to allow the annular compression member 502 to threadingly engage the tubular connector 220. When the annular compression member 502 engages the tubular connector 220, rotation of the annular compression member 502 therefore moves the annular compression member 502 axially towards or away from the body 202 of the valve assembly 200.

Still in the embodiment illustrated in FIGS. 5 to 8, the O-ring seal 504 is adapted to be disposed concentrically around the pipe 260 between the annular compression member 502 and the first end 204 of the body 202. Specifically, the O-ring seal 504 is adapted to be housed within a central circular recess 228 of the tubular connector 220 and to abut the first connector end 222 of the tubular connector 220. The O-ring seal 504 is made of an elastomeric material such as rubber or the like and therefore deforms when compressed, which creates a seal between the pipe 260 and the valve assembly 200 as will be further explained below.

In the illustrated embodiment, the coupling assembly 500 further comprises a bushing 520 disposed concentrically around the pipe 260 and located in the axial direction between the closed end portion 506 of the annular compression member 502 and the O-ring seal 504. The bushing 520 comprises a connector end portion 522 adapted to be located within the circular recess 228 of the tubular connector 220 and a compression end portion 524 which is adapted to be inserted within the central opening 508 of the closed end portion 506 of the annular compression member 502.

In the embodiment illustrated in FIGS. 5 to 8, the compression end portion 524 of the bushing 520 is tapered to guide it towards axial alignment into the central opening 508 of the annular compression member 502 when the annular compression member 502 is moved towards the bushing 520. This facilitates the coupling of the pipe 260 to the valve assembly 200. Alternatively, the central opening 508 of the annular compression member 502 could comprise a corresponding inner tapered surface portion, and both tapered portions could be adapted to mate with each other when the annular compression member 502 threadingly engages the tubular connector 220. In yet another embodiment, both the bushing's compression end portion 524 and the inner surface of the compression member's central opening 508 could simply be cylindrical.

Still in the embodiment illustrated in FIGS. 5 to 8, the bushing 520 further comprises an annular shoulder 526 which extends radially outwardly from the connector end portion 522 of the bushing 520. The annular shoulder 526 has an outer diameter which is greater than the inner diameter of the tubular connector 220. In this configuration, the annular shoulder 526 acts as a stop to prevent further movement of the bushing 520 towards the body 202 of the valve assembly 200 once the annular shoulder 526 abuts the tubular connector 220 as the annular compression member 502 is screwed towards the body 202 of the valve assembly 200.

Still in the embodiment illustrated in FIGS. 5 to 8, the bushing 520 further comprises an internal corrugated surface 527 adapted to engage the corresponding corrugated outer sidewall 262 of the pipe 260. Specifically, the bushing 520 comprises an internal annular rib 528 which is adapted to engage a first annular groove 278 of the pipe 260 located adjacent the first annular rib 274 of the pipe's outer sidewall 262. This configuration allows the bushing 520 to be positioned at a predetermined location near the first end 261 of the pipe 260 and prevents further movement of the bushing 520 relative to the pipe 260 once installed at the predetermined location. Alternatively, the bushing 520 may comprise more than one internal annular rib, the internal ribs being sized and shaped to engage adjacent annular grooves 270 of the pipe's outer wall 262. In yet another embodiment, the bushing 520 may not comprise any internal rib and may instead comprise a smooth inner cylindrical surface.

To facilitate installation of the bushing 520 on the pipe 260, the bushing 520 may comprise a split bushing. It will be appreciated that this type of bushing allows the bushing to be slightly expanded radially in order to clear the first annular rib 274 of the pipe's outer sidewall 262 and be allowed to slide along the pipe 260 until the internal annular rib 528 engages the first annular groove 278 of the pipe's outer sidewall 262. Alternatively, the bushing 520 may comprise a bushing with a continuous sidewall instead of a split bushing.

The bushing 520 is therefore adapted to contact simultaneously the annular compression member 502 and the O-ring seal 504. When the annular compression member 502 is rotated or screwed such that the annular compression member 502 moves axially towards the body 202 of the valve assembly 200, the distance between the bushing 520 and the second connector end 224 of the tubular connector 220 is reduced. The annular compression member 502 may be further rotated until the distance between the bushing 520 and the second connector end 224 of the tubular connector is further reduced, and the O-ring seal 504 is therefore compressed. It will be appreciated that when the O-ring seal 504 is compressed, its thickness is reduced such that the O-ring seal 504 is substantially flattened. Simultaneously, its inner diameter is diameter is reduced and its outer diameter is increased, such that the O-ring seal 504 is deformed from a circular cross-section to a substantially oblong cross-section. In this configuration, the O-ring seal 504 therefore radially outwardly abuts the tubular connector 220 and radially inwardly abuts the outer sidewall 262 of the pipe 260, thereby creating a seal between the pipe 260 and the valve assembly 200.

In the illustrated embodiment, the coupling assembly 500 further comprises a pipe end fitting 530 adapted to be mounted to the first end 261 of the pipe 260. Specifically, the pipe end fitting 530 is adapted to engage the outer sidewall 262 of the pipe 260.

In the embodiment illustrated in FIGS. 5 to 8, the pipe end fitting 530 comprises an inner ring 532 and an outer ring 534. The outer ring 534 includes a rigid portion 536 and a resilient portion 538 connected to the rigid portion 536 for engaging the outer wall 262 of the pipe 260. Specifically, the rigid portion 536 comprises a base ring 540 adapted to be disposed around the inner sidewall 264 of the pipe 260. The base ring 540 comprises a central opening 542 having a frustoconical inner sidewall 544 tapering towards the resilient portion 538.

Still in the embodiment illustrated in FIGS. 5 to 8, the resilient portion 538 comprises a plurality of resilient fingers 546 extending away from the base ring 540. The fingers 546 are spaced apart from each other and distributed along the base ring 540. Each finger 546 has a first end 548 connected to the base ring 540 and a second end 550 which is free. The fingers 546 are therefore disposed in a cantilevered configuration. Each finger 546 has a hinge portion 552 located at its first end 548 and a hook portion 554 located at its second end 550. The hinge portion 552 is relatively thin compared to the hook portion 554. The hook portion 554 extends radially outwardly from the hinge portion 552 and is adapted to be received in the underside of the first annular rib 274 of the pipe's outer sidewall 262.

Still referring to FIGS. 5 to 8, the inner ring 532 of the pipe end fitting 530 comprises an annular cap portion 556, an outer hook portion 558 and a frustoconical intermediate portion 560 connecting the annular cap portion 556 to the outer hook portion 558. The frustoconical intermediate portion 560 is tapered to an angle corresponding to the angle of the frustoconical inner sidewall 544 of the outer ring 534.

To mount the pipe end fitting 530 on the pipe's outer sidewall 262, the outer ring 534 is first disposed around the pipe's inner sidewall 264 with the fingers 546 facing towards the pipe 260. The outer ring 534 is then moved towards the pipe's outer sidewall 262 until the fingers 546 contact the rim 272 of the pipe's outer sidewall 262. As the outer ring 534 is moved further towards the pipe's outer sidewall 262, the fingers 546 are bent radially inwardly and allow the outer ring 534 to be moved further towards the pipe 260 and snapped onto the first end 261 of the pipe's outer sidewall 262. In this position, the hook portion 554 of the fingers 546 is located underneath the first annular rib and the rim 272 of the outer sidewall 262 is located over the hinge portion 552 of the fingers 546, between the hook portion 554 and the base ring 540 of the outer ring 534.

The inner ring 532 is then engaged with the outer ring 534 to lock the outer ring 534 on the pipe's outer sidewall 262. More specifically, the inner ring 532 is first disposed around the pipe's inner sidewall 264, with its outer hook portion 558 oriented towards the outer ring 534. The inner ring 532 is then pushed towards the outer ring 534 until the inner ring 532 snaps on the outer ring 534. In this configuration, the frustoconical intermediate portion 560 of the inner ring 532 mates with the frustoconical inner sidewall 544 of the outer ring 534. The outer hook portion 558 of the outer ring 534 also abuts an inner lip 562 of the outer ring 534 such that the inner ring 532 is prevented from being moved axially away from the outer ring 534. In this position, the outer hook portion 558 of the inner ring 532 abuts the underside of the outer ring's fingers 546 and thereby prevents the fingers 546 from bending radially inwardly, therefore holding the hook portions 554 of the fingers 546 behind the rim 272 of the pipe's outer sidewall 262. The outer ring 534 is therefore held on the pipe's outer sidewall 262 and is prevented from moving relative to the pipe 260 by the inner ring 532.

In this position, the entire pipe end fitting 530 is therefore prevented from moving relative to the pipe's outer wall 262. It will be appreciated that when a piece of pipe is cut, the rim created is often sharp and may cause injury to a user manipulating the pipe, for instance in order to connect the pipe's outer sidewall to. The pipe end fitting 530 therefore provides protection to the user by covering and being held over the rim 272 of the pipe's outer sidewall 262.

In the embodiment illustrated in FIGS. 5 to 8, the pipe end fitting 530 is received in a bore 600 which is defined in the body 202 at the outlet 212 of the primary passageway 208. More specifically, the bore 600 has a diameter which is generally similar to the diameter of the inner ring's annular cap portion 556.

Still in the illustrated embodiment, the inner ring 534 is slightly radially spaced from the pipe's inner sidewall 264 to allow fluid communication between the second fluid line and the bore 600. This allows the second fluid line to be in fluid communication with the secondary passageway 214 to allow the valve assembly 200 to be operated by a pressure differential in certain conditions, as explained above.

Still in the embodiment illustrated in FIGS. 5 to 8, the body 202 of the valve assembly 200 further comprises a seal housing chamber 602 extending from the bore 600 into the body 202. The valve assembly 200 further comprises a pair of O-ring seals 604 adapted to be disposed around the inner sidewall 264 of the pipe 260 and to be received in the seal housing chamber 602. It will be appreciated that the O-ring seals 604 contribute to preventing fluid communication between the inner and outer fluid lines. Alternatively, only a single O-ring seal could be provided around the pipe's inner sidewall 264, or more than two O-ring seals could be provided.

Still in the illustrated embodiment, the O-ring seals 604 are retained within the seal housing chamber 602 by a retainer ring 606 located between the bore 600 and the seal housing chamber 602. The retainer ring 606 engages a retaining groove 608 and is thereby prevented from moving relative to the body 202. In one embodiment, the retainer ring 606 is split to facilitate its installation. More specifically, the retainer ring 606 can be resiliently deformed to temporarily reduce its diameter in order to engage the retainer ring 606 into the retaining groove 608.

Furthermore, the retainer ring 606 may have a tapered inner surface 609 oriented towards the bore 600 for guiding the pipe's inner sidewall 264 through the retainer ring 606 during insertion of the pipe's inner sidewall 264 into the body 202. Alternatively, the retainer 606 may not have a tapered inner surface.

Still in the embodiment illustrated in FIGS. 5 to 8, the coupling assembly further comprises a collar 610 which is adapted to be disposed around the inner sidewall 264 of the pipe 260. The collar 610 is adapted to engage the pipe's inner sidewall 264 such that the collar 610 is prevented from moving relative to the pipe's inner sidewall 264. The collar 610 is disposed within the bore 600, between the pipe end fitting 530 and the seal housing chamber 602. The collar 610 has a diameter which is greater than the inner diameter of the pipe end fitting 530 to thereby prevent the pipe's inner sidewall 264 from being pulled out from the bore 600 and from the body 202.

It will be appreciated that various other embodiments may be contemplated. For example, the pipe end fitting 530 could be made of a single ring instead of an inner ring and an outer ring. Alternatively, the coupling assembly 500 may not comprise a pipe end fitting 530 at all. Instead, the first end 261 of the pipe's outer sidewall 262 may be directly engaged into the bore 600 at the outlet 212.

In another embodiment, the inlet 210 and the outlet 212 of the primary passageway 208 may be reversed, such that the pipe 260 is connected to the inlet 210 instead of the outlet 212.

In yet another embodiment, the valve assembly 200 could be generally similar to the valve assembly 10 shown in FIGS. 1 and 2 instead of the valve assembly 110 shown in FIGS. 3 and 4.

In yet another embodiment, the pipe 260 may be a standard single-walled pipe instead of a double-walled pipe.

In yet another embodiment, the coupling assembly 500 may be used to connected a pipe to any type of bodies comprising a passageway and a tubular connector. It will be appreciated that this coupling 500 may be useful to quickly and easily connect a pipe to a plumbing element or the like.

Although the above description relates to a specific preferred embodiment as presently contemplated by the inventor, it will be understood that the discovery in its broad aspect includes mechanical and functional equivalents of the elements described herein.

I claim:

1. A valve assembly comprising:
a body having a first end, a second end and a tubular connector extending away from the second end, the tubular connector being sized and shaped to receive a pipe having an outer sidewall and a first fluid line, the tubular connector having a first connector end located towards the second end of the body and a second connector end located away from the second end of the body, the tubular connector further having a threaded outer surface;
a primary passageway defined through the body and the tubular connector, the passageway having a first end coinciding with the first end of the body and a second end coinciding with the second connector end, the second end of the primary passageway being adapted to be connected to the first fluid line;
a valve disposed in the primary passageway between the first end and the second end thereof, the valve being movable between a first position in which the primary passageway is open and fluid communicates between the first end and the second end of the primary passageway, and a second position in which the primary passageway is closed and fluid is prevented from communicating between the first end and the second end of the primary passageway; and
a coupling assembly for sealingly connecting the pipe to the body, the coupling assembly including:
an annular compression member disposed concentrically around the tubular connector, the annular compression member being further adapted to be disposed around the outer sidewall of the pipe, the annular compression member threadingly engaging the threaded outer surface of the tubular connector such that rotation of the compression member selectively moves the annular compression member axially towards and away from the body; and
an O-ring seal adapted to be disposed concentrically around the outer sidewall of the pipe between the annular compression member and the first end of the body, the O-ring being compressed when the annular compression member is moved towards the body to create a seal between the pipe and the body.

2. The valve assembly as claimed in claim 1, wherein the coupling assembly further comprises a bushing adapted to be disposed concentrically around the pipe, between the annular compression member and the O-ring seal.

3. The valve assembly as claimed in claim 2, wherein the bushing comprises a corrugated internal surface adapted to engage a corresponding corrugated external surface of the pipe.

4. The valve assembly as claimed in claim 1, further comprising a fitting assembly mounted to the outer sidewall of the pipe, the fitting assembly being adapted to be received within a bore of the body, the bore being located at the second end of the primary passageway.

5. The valve assembly as claimed in claim 4, wherein the fitting assembly comprises an outer ring adapted to engage a first end of the outer sidewall of the pipe and an inner ring adapted to engage the outer ring for locking the outer ring on the outer sidewall of the pipe.

6. The valve assembly as claimed in claim 5, wherein the outer ring comprises a base ring and a plurality of resilient fingers extending from the base ring.

7. The valve assembly as claimed in claim 6, wherein the base ring is adapted to receive an inner sidewall of the pipe, the inner sidewall being spaced radially inwardly from the outer sidewall.

8. The valve assembly as claimed in claim 7, wherein the fitting assembly comprises a collar adapted to be disposed around the inner sidewall of the pipe, the collar being located within the bore of the body, the inner ring member of the fitting assembly having an inner diameter and the clamp member having an outer diameter greater than the inner diameter of the inner ring.

9. The valve assembly as claimed in claim 1, further comprising a secondary passageway defined in the body, the secondary passageway having a first end and a second end, the secondary passageway being fluidly isolated from the primary passageway, the second end of the secondary passageway being adapted to be connected to a second fluid line of the pipe, the first fluid line being disposed coaxially within the second fluid line.

10. The valve assembly as claimed in claim 9, wherein the first pressure in the primary passageway is greater than the second pressure in the secondary passageway, and an environment pressure is greater than the second pressure in the secondary passageway.

11. The valve assembly as claimed in claim 10, wherein the valve assembly has at least one safety mode whereby the valve closes the primary passageway in response to an increase of the second pressure in the secondary passageway.

12. The valve assembly as claimed in claim 11, wherein an increase of the second pressure in the secondary passageway is a consequence of at least one of a leak between the first fluid line and the second fluid line and a leak between the second fluid line and the environment.

13. The valve assembly as claimed in claim 1, wherein the valve includes a spring loaded ball selectively abutting a seat of the primary passageway;
in the open position, the ball is spaced away from the seat;
in the closed position, the ball abuts the seat; and
the spring biases the ball toward the closed position.

14. The valve assembly as claimed in claim 13, further comprising a piston selectively abutting the ball;
the piston is disposed vertically below the ball opposite from the spring;
the piston is movable between an upper position and a lower position,
wherein in the upper position, the piston abutting the ball and displacing the ball upward away from the seat thereby moving the valve in the open position;
in the lower position, the piston induces the ball to move downward toward the seat thereby moving the valve in the closed position.

15. The valve assembly of claim 14, wherein in the upper position, the piston abuts the ball;
in the lower position, the piston is spaced away from the ball and lets the ball move downward toward the seat under the influence of the spring.

16. A coupling assembly for sealingly connecting a pipe to a body, the body having a first end, a second end and a tubular connector having a first connector end connected to the second end of the body and a second connector end located away from the second end of the body, the body further having a primary passageway defined through the body and the tubular connector, the tubular connector further having a threaded outer surface, the coupling assembly comprising:
an annular compression member adapted to be disposed concentrically around the tubular connector, the annular compression member being further adapted to be disposed around the pipe, the annular compression member threadingly engaging the threaded outer surface of the tubular connector such that rotation of the compression member selectively moves the annular compression member axially towards and away from the body; and
an O-ring seal adapted to be disposed concentrically around the pipe between the annular compression member and the first end of the body, the O-ring being compressed when the annular compression member is moved towards the body to create a seal between the pipe and the body.

17. A valve system comprising:
a pipe having an outer sidewall and an inner sidewall spaced radially inwardly from the outer sidewall to define an interstitial space therebetween, the inner sidewall defining a first fluid line and the interstitial space defining a second fluid line;
a valve assembly including:
a body having a first end, a second end and a tubular connector extending away from the second end, the tubular connector being sized and shaped to receive the pipe, the tubular connector having a first connector end located towards the second end of the body and a second connector end located away from the second end of the body, the tubular connector further having a threaded outer surface;
a primary passageway defined through the body and the tubular connector, the passageway having a first end coinciding with the first end of the body and a second end coinciding with the second connector end, the second end of the primary passageway being adapted to be connected to the first fluid line;
a valve disposed in the primary passageway between the first end and the second end thereof, the valve being movable between a first position in which the primary passageway is open and fluid communicates between the first end and the second end of the primary passageway, and a second position in which the primary passageway is closed and fluid is prevented from communicating between the first end and the second end of the primary passageway; and
a coupling assembly for sealingly connecting the pipe to the body, the coupling assembly including:
an annular compression member disposed concentrically around the tubular connector, the annular compression member being further adapted to be disposed around the outer sidewall of the pipe, the annular compression member threadingly engaging the threaded outer surface of the tubular connector such that rotation of the compression member selectively moves the annular compression member axially towards and away from the body; and
an O-ring seal adapted to be disposed concentrically around the outer sidewall of the pipe between the annular compression member and the first end of the body, the O-ring being compressed when the annular compression member is moved towards the body to create a seal between the pipe and the body.
